(19) United States
(12) Patent Application Publication
(10) Pub. No.: US 2011/0284442 A1
(43) Pub. Date: Nov. 24, 2011

(54) Pond Post-Vacuuming Filtration Bag

(76) Inventor: Emile Anthony Williams, Valrico, FL (US)

(21) Appl. No.: 12/786,251

(22) Filed: May 24, 2010

(51) Int. Cl. E02B 15/00; B01D 29/11

(52) U.S. Cl. 210/170.09

(57) ABSTRACT

This invention is designed to allow the user to not only recycle water to the pond but also to save water which can be a huge contributor to protecting the environment as a whole. The employment of varying filter media also ensures that the water returned to the pond is polished and is the same temperature as that removed, rendering the fish protection from shock which may ensue due to varying water temperatures.

### BACKGROUND OF THE INVENTION

A number of different types of filters are known in the art for filtering surface water. Patents of interest in this regard include:

U.S. Pat. No. 4,606,819, issued Aug. 19, 1986, to Colson;

U.S. Pat. No. 7,601,258, issued Oct. 15, 2007, to James;

U.S. Pat. No. 7,575,677, issued Aug. 18, 2009, to Barnes;

U.S. Pat. No. 4,643,836, issued Feb. 17, 1987, to Schmid;

U.S. Pat. No. 4,657,672, issued Apr. 14, 1987, to Allen;

U.S. Pat. No. 4,950,393, issued Aug. 21, 1990, to Goettl;

U.S. Pat. No. 5,160,039, issued Nov. 3, 1992, to Colburn;

U.S. Pat. No. 5,549,828, issued Aug. 27, 1996, to Ehrlich;

U.S. Pat. No. 6,027,639, issued Feb. 22, 2000, to J. Lenhart

U.S. Pat. No. 7,273,544, issued Sept. 25, 2007, to Hoffmeier et al, details a continuous Pond Vacuum that may benefit from this current invention.

The above cited prior art does not provide a suitable means for reliably and automatically removing debris via pond vacuum, and subsequently returning said filtered water to the pond.

Consequently, there has been a need to provide improved and more reliable apparatus and methods that result in continuous circulation of water with minimal loss of water. Those of skill in the art will greatly appreciate the present invention which addresses the above problems and other problems.

### SUMMARY OF THE INVENTION

Most pond vacuums allow the user to vacuum leaves, sludge and other waste from their pond, and discard the water produced from this exercise into the flower garden or lawn. This practice is very effective in terms of removing waste from the pond but it does involve losing quite a lot of water in the process.

This filter bag is used to enable the user to return the normally discarded water to the pond through a four-stage filtration bag that separates the leaves, and sludge before returning the water completely polished to the pond.

This method would save hundreds of gallons of water every year, for anyone using such filtration, not to mention the impact on the environment in saving valuable water.

The system consists of four bags, a net bag that allows the trapping of all leaves and large debris, this net bag is enclosed by high density layers of graduated filtration fabric allowing further removal of finer debris and flocculants from the water. The net bag is constructed with a pull string attachment at its open end to allow the bag to be removed and emptied while vacuuming, in the event the net becomes full before the vacuuming exercise is complete.

The additional three stages of filtration of this system comprises of bags constructed of filter type material, each independent of the other allowing separation after removal for easy cleaning. In addition each stage utilizes multiple layers of the same material, this eliminates channeling which is the major reason for most filtration systems failure to efficiently remove waste. The water after passing through these stages of filtration is dumped directly back into the pond.

The Filtration bag is attached to the discharge end of the pond vacuum by means of the two pull string assemblies. The first pull string assembly is attached to the net bag, and the second is attached to the final filtration material the fine mesh bag.

After completing vacuuming, the bags can be removed and the varying filtration stages separated from each other and cleaned for reuse.

The outer bag is constructed of a fine mesh material filled with activated carbon material that will also aid in filtration while having sufficient perforations to allow efficient flow of water back into the pond.

### Method Of Use

Before beginning vacuuming the post-filtration bag is attached to the output end of the discharge tube in the following manner.

The leaf bag is attached to the output end of the discharge tube by placing the open end of the net bag over and around the opening, and pulling the pull-string system tight around the tube's end.

The second layer of filtration comprising of a foam bag is placed within the third layer of filtration which is a batting bag, which altogether is placed inside the fourth stage of filtration which is a fine mesh bag filled with activated carbon material.

This final stage of filtration the fine mesh bag has a pull string on its open end which allows the bag to be pulled tight and secured around the output end of the discharge tube as well.

The discharge tube with the bags securely attached is now placed in a position that allows the bag to hang loosely into the water of the pond while allowing the end of the discharge tube to remain submerged no more than two inches under the surface of the pond. (In so doing allowing the user to monitor the bags in case they are full and need emptying).

The vacuum is now turned on allowing the intake nozzle to extract water from the pond in the normal manner prescribed by the manufacturer.

If during the vacuum process it is noticed that the leaf bag is full and impeding the discharge of water from the post filter, simply switch off the vacuum, detach the outer bag, then the leaf net bag, empty its contents and replace into its original position.

The same pertains to the other two filtration stages if observed to be full, remove clean by dumping debris and possibly spraying with a hose to dislodge fine debris. Then return to its original position over the leaf bag and secure to discharge output as previously done.

On completion of vacuuming the post filtration bags can be removed, separated, emptied, cleaned thoroughly, and stored for future use.

The filtration bags can be individually replaced whenever they are deemed to be worn.

### BACKGROUND ART

This invention relates to water filters and more particularly, to water filtration systems that waste water in the process of achieving this goal. The pond vacuum systems presently being utilized are capable of removing sludge and debris from a fish pond or water feature in a very efficient manner. The only aspect not addressed in the process is a means of protecting the environment by conserving the water that is being treated. This can be achieved by devising a method of recycling, and reusing the processed water in a manner that does not hurt the environment or the fish or live media within the pond.

This process utilizes the practice of circulation of filtered water through varying filtration medium, and returning the filtered water to the pond. The post vacuum filtration system is submerged into the pond.

The utilization of foam, activated carbon and batting as filtration medium, is not new in filtration practice, but the method in which they are utilized, namely as individualized bags, which can be separated for cleaning or for replacement when worn, adds to the practicality of this system.

There currently exists various types of filtration systems that filter water then returned the resulting water to the pond. These come in the form of sand filters, bio ball filters, to name a few. This invention in particular pertains to being used in conjunction with pond vacuum systems.

### GENERAL DESCRIPTION AND PREFERRED MODES OF INVENTION

The present invention provides a novel approach to liquid treatment and circulation as preferred embodiment of which may be utilized for filtering and treating water for fish ponds, waterfalls, and fountains.

The present invention provides a post vacuuming filter that potentially filters and polishes waste water to the extent that the water can be returned directly to the pond from which it was extracted. The present invention provides a means of protecting the environment by saving water.

The foregoing disclosure and description of the invention is therefore illustrative and explanatory of a presently preferred embodiment of the invention and variations thereof, and it will be appreciated by any individual or enthusiast who as struggled with saving water while affecting vacuuming. As well, the drawings are intended to describe the concepts of the invention so that the presently preferred embodiments of the invention will be plainly disclosed to hobbyists familiar with the practice of pond filtration, but are not intended to be manufacturing level drawings or renditions of final products and may include simplified conceptual views.

Thus, various changes and alternatives may be utilized that remain within the spirit of the invention. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

### BRIEF DESCRIPTION OF DRAWINGS

These and other features will become more apparent from the following description in which reference is made to the appended drawings, the drawings are for the purpose of illustration only and are not intended to be in any way limiting, wherein:

FIG. 1 is a side elevation of the (4) stages of filtration, of the post vacuum system, showing the four (4) bags utilized.

FIG. 2 is a three dimensional view of how the four stages of filtration bags fit into each other to provide the filtration.

FIG. 3 is an illustrative drawing demonstrating how the bag is utilized in conjunction with the process of vacuuming a pond.

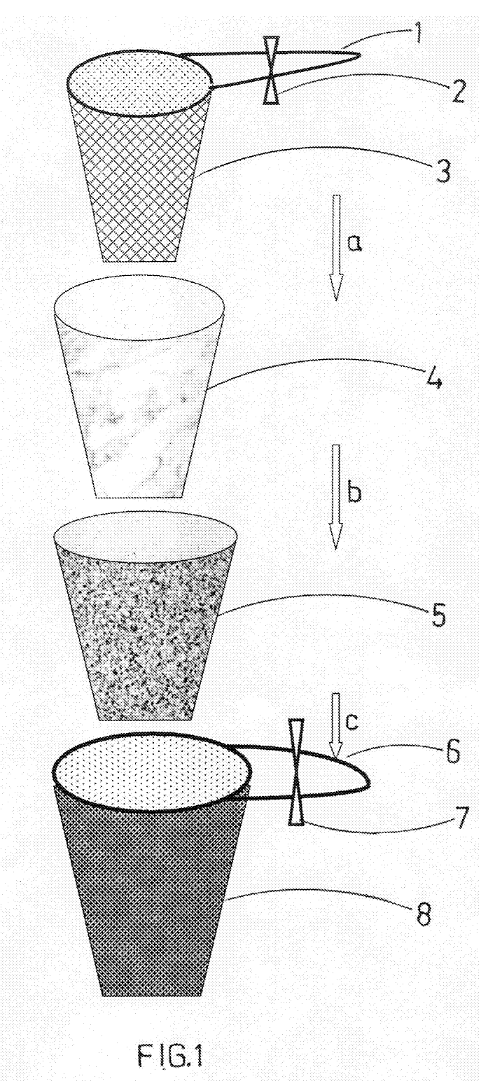

FIG. 1 shows stage 1 of filtration the net bag 3 with its drawstring 1 and fastener 2, followed by stage 2 filtration the foam bag 4, followed by stage 3 the batting bag 5. The fourth and final stage the fine mesh bag filled with activated carbon, also carries a drawstring 6 and fastener 8.

The arrows a, b, and c in FIG. 1 demonstrate the direction in which the four filtration bags are fit together in order to effect the post vacuum filtration system.

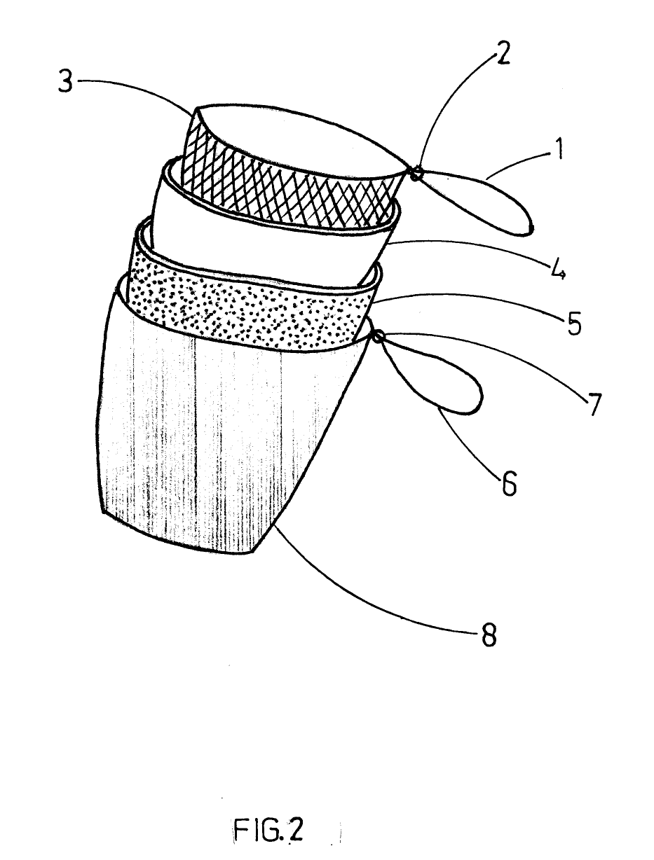

FIG. 2 demonstrates the method in which the four bags are placed within each other in order that graduated filtration is accomplished.

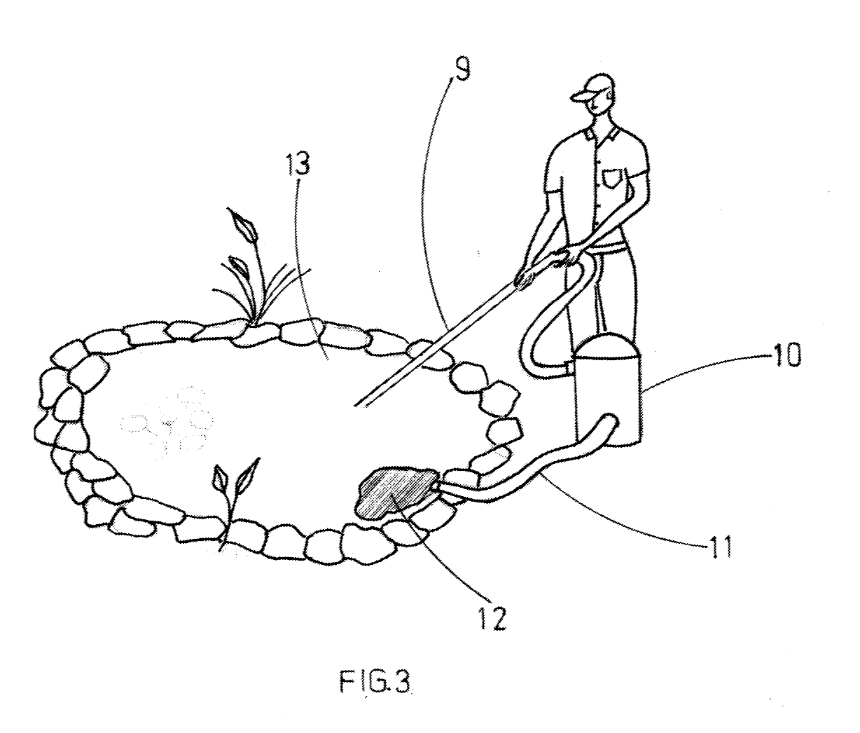

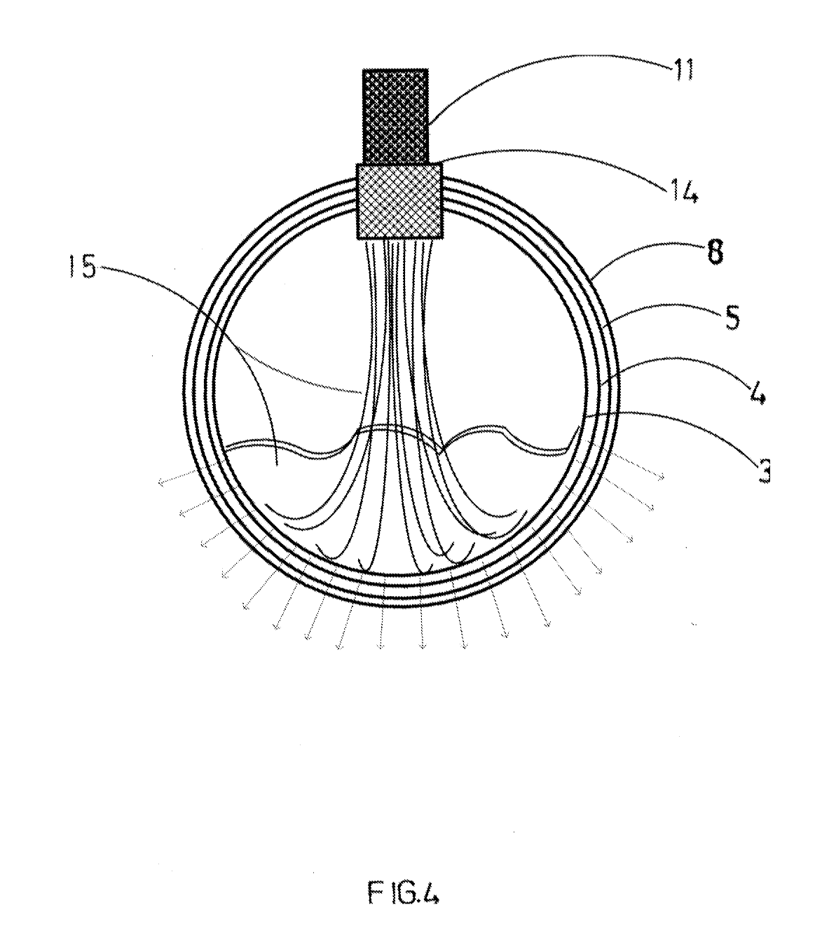

Referring now to one embodiment illustrated in FIG. 3 whereby the water is sucked from the fish pond 13 into the pond vacuum 10 via the intake hose 9, the water entering the vacuum 10 consists of waste matter such as leaves, sludge and other unwanted debris. This water is then discharged as waste out of the discharge hose 11 of the vacuum 10 into the post vacuum filtration system 12 which is positioned in a submerged position at the outer perimeter of the fish pond 13 just two to three inches below the pond's 13 surface.

The waste water entering the post vacuum filtration system first passes through the net bag 3, where all large particles of debris are trapped the water then proceeds through the foam bag 4 which then removes sand and gravel size particles. The water then proceeds through the batting bag 5 which removes waste micro sized particles from the water. The water finally passes through the fine netting mesh containing activated carbon 8 which removes any other particles along with odor that may have gotten through the previous four stages.

FIG. 2 illustrates the method in which elements 3, 4, 5, and 8 fit into each other to form the post vacuum filtration system. Along with the pull strings 1 and 6 and the respective fasteners 2 and 8.

FIG. 4 is a cross-sectional representation of the operational aspects of the post vacuum filtration system, showing the discharge hose 11, and its discharge nozzle 14. The water 15 being discharged into the post filtration system and its passage through the four filtration stages. First passing through the net bag 3, then through the foam bag 4, then through the batting bag 5 and finally the activated carbon fine mesh bag 8. Resulting in the filtered water 16.

1. A post vacuum filtering system for filtering discharged waste liquid, said filter assembly being connectable to the posterior end of a discharge tube of a pond vacuum which comprises of an intake hose that sucks water from a pond, a vacuum to effect such suction and a discharge hose that directs the waste water into a garden or other surface.

2. A discharge tube that is utilized by pond vacuum systems which allows the discharge of waste liquid removed by vacuuming from a pond or lake.

3. The post vacuum filtering system of claim 1 comprising of a plurality of filtering stages capable of removing various sizes of waste from the said waste water and discharging the said filtered liquid back into said pond.

4. The post vacuum filtration system of claim 1, further comprises of four filtration bags presenting four graduated filtration mediums, each one encompassing the other so as to create a tiered method of filtration.

5. The said bags of claim 4 are placed one inside the other with their openings coinciding with each other, the outer bag being made of an ultra fine mesh filled with activated carbon material and having at its open end a pull-string assembly that would allow attachment to the posterior end of the said discharge tube of claim 2.

6. The post vacuum filtering system of claim 1 comprising of multiple pull string assemblies to enable the attachment of the said post vacuum filtering system to the collar end of the said discharge tube assembly.

7. The plurality of four filtration bags of claim 4 that are layered such that the first said filtration medium that the wastewater flows through comprises of a net bag.

8. The said net bag of claim 7 comprises of an open end with a pull string assembly that allows the said net bag to be attached to the said posterior end of said discharge tube assembly.

9. The said net bag of claim 7 which further comprises of a net that is capable of trapping large debris such as leaves and twigs.

10. The plurality of four filtration bags of claim 4 which has as its second layer of filtration a foam bag, which removes debris the size of play sand or larger, from the said waste liquid as it passes through.

11. The said foam bag of claim 10, comprising of a dense foam material half inch thick.

12. The plurality of filtration bags of claim 4 that has as its third layer of filtration a batting bag which is constructed slightly larger than the foam bag of claim 10, so as to allow the said foam bag to fit into the said batting bag.

13. The plurality of filtration bags of claim 4 that has as its third layer of filtration a batting bag such that debris the size of flocculants and larger can be separated from the said waste liquid as it passes through.

14. The said batting bag of claim 13, comprising of a batting material half inch thick.

15. The plurality of filtration bags of claim 4 has as its fourth and final layer a fine mesh bag filled with activated carbon that is constructed slightly larger than the batting bag of claim 12 to allow the said batting bag to fit into the said fine mesh bag.

16. The plurality of filtration bags of claim 4 that has as its fourth and final layer a fine mesh bag filled with activated carbon which filters any remaining debris that may have been missed in prior filtration phases along with removing odor.

17. The ultra fine mesh bag of claim 15 has an opening on one end that is sufficiently large enough to fit over the nozzle of the posterior end of the said vacuums' discharge tube, with a pull-string assembly that is capable of affixing tightly around the opening of the said discharge tubes' outlet.

18. The fine mesh bag of claim 15 having at its open end a pull string assembly that enables the said fine mesh bag to be attached to and over the said posterior end of said discharge tube assembly. The resulting product is returned to the said pond by submerging the post vacuum filtering system of claim 1 below the surface of the said pond surface.
